(19) United States
(12) Patent Application Publication
(10) Pub. No.: US 2025/0172425 A1
(43) Pub. Date: May 29, 2025

(54) FILL-LEVEL METER

(71) Applicant: Endress+Hauser SE+Co. KG, Maulburg (DE)

(72) Inventors: Markus Vogel, Schopfheim (DE); Ghislain Daufeld, Village Neuf (FR); Alexey Malinovskiy, Maulburg (DE); Markus Ziegler, Lörrach (DE)

(21) Appl. No.: 18/843,487

(22) PCT Filed: Feb. 20, 2023
(86) PCT No.: PCT/EP2023/054232

§ 371 Date: Sep. 3, 2024

(30) Foreign Application Priority Data
Mar. 24, 2022 (DE) 10 2022 105 195.1

(51) Int. Cl. G01F 23/284; G01S 7/35; G01S 13/32

(52) U.S. Cl. CPC G01F 23/284; G01S 7/356; G01S 13/32

(57) ABSTRACT

The invention relates to an FMCW radar-based distance meter by means of which the distance to an object can be reliably determined. The distance meter comprises at least: a signal generation unit for generating corresponding high-frequency signals; an HF antenna for transmitting and receiving the radar signals; and an evaluation unit typical for FMCW. The evaluation unit includes an additional averaging stage that averages the intermediate-frequency signal in the signal direction over time before the frequency spectrum is created. This significantly improves the signal-to-noise ratio of the intermediate-frequency signal. Overall, the correct maximum in the frequency spectrum, said maximum representing the distance, can thus be determined in a significantly more reliable manner.

The invention relates to a radar-based fill-level meter by means of which the fill level can be reliably determined.

In process automation technology, corresponding field devices are used for capturing relevant process parameters. For the purpose of capturing the particular process parameters, suitable measuring principles are therefore implemented in the corresponding field devices in order to capture as process parameters, for example, a fill level, a flow, a pressure, a temperature, a pH value, a redox potential, or a conductivity. The Endress+Hauser corporate group manufactures and distributes a wide variety of field device types.

For measuring the fill level of filling materials in containers, contactless measuring methods have become established, since they are robust and require minimum maintenance. A further advantage of contactless measuring methods consists in the ability to be able to measure the fill level quasi-continuously. Radar-based measuring methods are therefore predominantly used in the field of continuous fill-level measurement (in the context of this patent application, the term “radar” refers to signals or electromagnetic waves with frequencies between 0.03 GHz and 300 GHz). In principle, the higher the frequency is, the higher is the achievable measurement resolution. FMCW (“frequency modulated continuous wave”) has become established as a measuring method. Radar-based fill-level measurement is described in greater detail in “Radar Level Detection, Peter Devine, 2000,” for example.

The functional principle of FMCW is based on transmitting a radar signal with a frequency changing in a ramp-like manner. After reflection on the surface of the filling material, the corresponding received signal is mixed by signaling technology with the generated radar signal in order to obtain a low-frequency intermediate-frequency signal. In the ideal case, i.e., without noise and external interference such as interference reflections, the intermediate-frequency signal is sinusoidal with a defined frequency. The frequency of the intermediate-frequency signal represents the distance to the filling material, or the fill level. In order to ascertain the frequency of the intermediate-frequency signal in order to determine the fill level, the intermediate-frequency signal is subsequently converted into a frequency spectrum by Fourier transform. The absolute maximum of the frequency spectrum represents the fill level.

However, in the case of interference and component-related noise, it becomes more difficult to determine from the frequency spectrum the maximum that can be assigned to the fill level, since this also creates frequency maxima. In extreme cases, this can lead to the fill-level meter ascertaining an incorrect fill-level value, which, depending on the processing system, can be associated with correspondingly critical situations. In general, it is known in this respect to filter the received signal directly after reception or to average the frequency spectra of a plurality of measurement cycles over time. However, direct filtering of the received signal does not lead to a significant improvement in the signal-to-noise ratio. Averaging leads to trailing effects, such as ghost echo cancellation, etc., when process conditions change. The invention is therefore based on the object of providing a radar-based meter that is improved in this respect.

The invention achieves this object by an FMCW radar-based distance meter for measuring a distance to an object, which comprises the following components:
a signal generation unit designed to generate a respective electrical high-frequency signal in successive measurement cycles according to the FMCW method, such as a PLL or phase locked loop,
an antenna by means of which the high-frequency signal can be transmitted as a radar signal in the direction of the object and, after reflection on the object, can be received as a corresponding received signal, and
an evaluation unit, with
   a mixer stage designed to generate a low-frequency intermediate-frequency signal per measurement cycle on the basis of the electrical high-frequency signal and the received signal according to the FMCW principle,
   a transformer stage designed to create a frequency spectrum of the evaluation signal per measurement cycle,
      wherein the evaluation unit is designed to determine the distance on the basis of the frequency spectrum.

According to the invention, the evaluation unit is characterized by an averaging stage designed to average the intermediate-frequency signal in the signal direction over time before the frequency spectrum is created. This allows the signal-to-noise ratio to be significantly improved so that the corresponding frequency maximum in the frequency spectrum can be ascertained much more reliably. If the distance meter additionally comprises an analog/digital converter stage which digitizes the intermediate-frequency signal in the signal direction before the averaging stage, the averaging according to the invention also averages out any limited A/D converter resolution and associated inaccuracies. Within the scope of the invention, there are no strict specifications as to how or to what degree the averaging is carried out. For example, the averaging stage can average the intermediate-frequency signal over time using arithmetic averaging, summation, median formation, using an FIR or IIR.

Due to the high reliability with which the correct distance can be determined, the distance meter can be used in particular to measure a fill level of filling material in a container.

In particular, the averaging stage can be designed in such a way that it changes or completely deactivates the averaging over time of the intermediate-frequency signal in the particular measurement cycle, depending on
a change in the distance ascertained in the current measuring cycle in comparison to the distance ascertained in a previous measurement cycle,
a correlation between the frequency spectrum or intermediate-frequency signal ascertained in the current measurement cycle and the frequency spectrum or intermediate-frequency signal recorded in a previous measurement cycle, or
an average absolute deviation between the intermediate-frequency signal recorded in the current measurement cycle and the intermediate-frequency signal recorded in a previous measurement cycle. In this case, the averaging stage can change the degree of averaging over time of the intermediate-frequency signal preferably depending on the change in distance, the correlation or the deviation in the current or subsequent measurement cycle in such a way that
the degree of averaging decreases as
   the change in distance increases
   the correlation decreases, and/or
   the deviation increases, or
the degree of averaging increases as
   the correlation increases,
   the change in distance decreases, and/or
   the deviation decreases.

This in particular makes it possible to minimize trailing effects in the frequency spectrum.

Correspondingly to the distance meter according to the invention, the corresponding method for measuring the distance to an object using the FMCW principle comprises the following method steps, which are repeated in successive measurement cycles:
generating the electrical high-frequency signal according to the FMCW method,
transmitting the high-frequency signal as a radar signal in the direction of the object,
receiving the corresponding received signal after reflection on the object,
mixing the electrical high-frequency signal and the received signal to form a low-frequency intermediate-frequency signal,
averaging the intermediate-frequency signal over time,
creating a frequency spectrum of the evaluation signal averaged over time, and
determining the distance on the basis of the frequency spectrum.

In the context of the invention, the term “unit” is understood in principle to mean a separate arrangement or encapsulation of the electronic circuits that are provided for a specific application, for example for high-frequency signal processing or as an interface. Depending upon the application, the particular unit may therefore comprise corresponding analog circuits for generating or processing corresponding analog signals. However, the unit may also comprise digital circuits, such as FPGAs, microcontrollers, or storage media in interaction with corresponding programs. The program is designed to carry out the required method steps or to apply the necessary computing operations. In this context, different electronic circuits of the unit in the sense of the invention can also potentially access a common physical memory or be operated by means of the same physical digital circuit. In this case, it does not matter whether different electronic circuits within the unit are arranged on a common printed circuit board, or on a plurality of connected printed circuit boards.

The invention is explained in more detail on the basis of the following figures. In the figures:

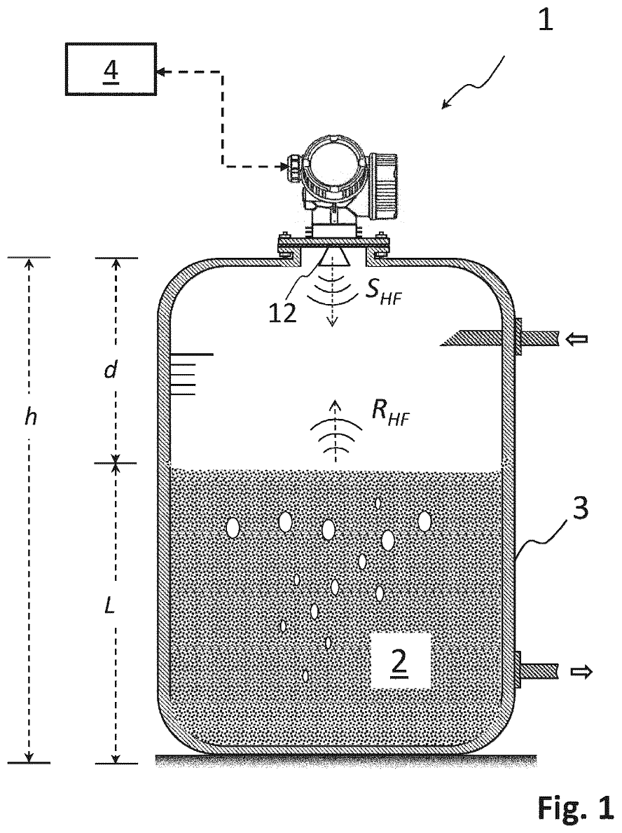

FIG. 1: shows a radar-based fill-level meter on a container, and

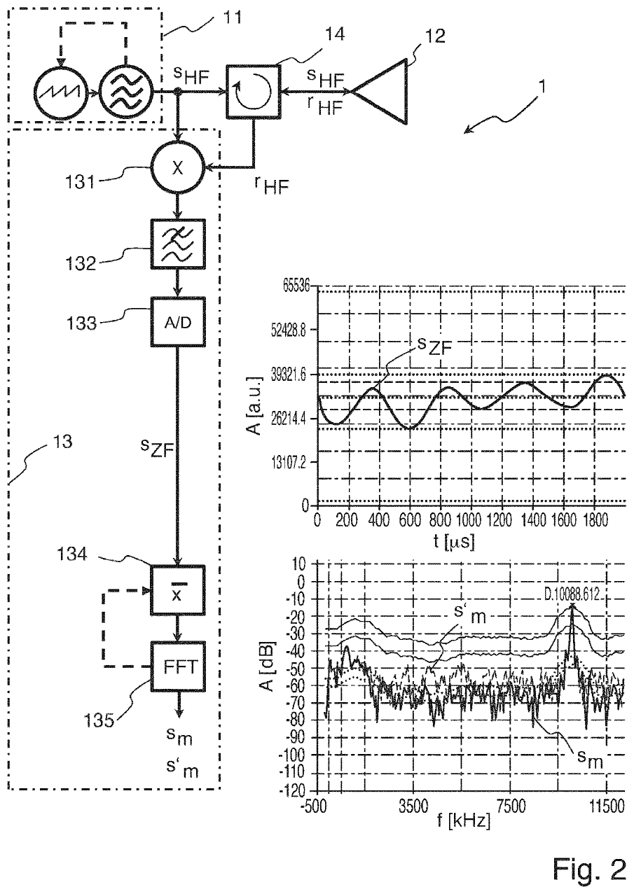

FIG. 2: is a block diagram of the fill-level meter according to the invention.

In FIG. 1, the invention is explained below in more detail on the basis of radar-based fill-level measurement. For basic understanding, FIG. 1 therefore shows a container 3 with a filling material 2, the fill level L of which is to be determined. The container 3 can be up to more than 100 m high, depending upon the type of filling material 2 and depending on the field of application. The conditions in the container 3 are also dependent upon the type of filling material 2 and the field of application. In the case of exothermic reactions, high temperature and pressure loads may occur, for example. In the case of dust-containing or flammable substances, appropriate explosion protection conditions must be observed in the container interior.

In order to be able to ascertain the fill level L independently of the prevailing conditions, a fill-level meter 1 operating according to the FMCW principle is installed above the filling material 2 at a known installation height h above the bottom of the container 3. The fill-level meter 1 is attached and aligned in such a pressure- and media-tight manner to a corresponding opening of the container 3 that only the antenna 12 of the fill-level meter 1 is directed vertically downward into the container 3 toward the filling material 2, while the other components of the fill-level meter 1 are arranged outside the container 3.

Radar signals S_{HF} are transmitted via the antenna 12 within a predefined frequency band in the direction of the surface of the filling material 2.

According to the FMCW principle, the frequency of the radar signal S_{HF} is changed in a ramp-like manner within this frequency band, for example from 119 GHz to 121 GHz, per measurement cycle. After reflection on the filling material surface, the fill-level meter 1 receives the reflected received signals R_{HF}, again via the antenna 12. The resulting signal propagation time t between transmission and reception of the corresponding radar signals S_{HF}, R_{HF} is, according to

$$t = \frac{2 * d}{c}$$

correspondingly proportional to the distance d between the fill-level meter 1 and the filling material 2, wherein c is the radar propagation speed of the corresponding speed of light. The signal propagation time t can be determined indirectly from the received signal R_{HF} by the fill-level meter 1 using the FMCW method, as explained with reference to FIG. 2. For example, on the basis of a corresponding calibration, the fill-level meter 1 can assign the measured propagation time t to the corresponding distance d. In this way, the fill-level meter 1 can, according to

$$d = h - L$$

in turn determine the fill level L if the installation height h is stored in the fill-level meter 1.

In general, the fill-level meter 1 is connected to a higher-level unit 4, such as a local process control system or a decentralized server system, via a separate interface unit, such as “4-20 mA,” “PROFIBUS,” “HART,” or “Ethernet.” In this way, the measured fill-level value L can be transmitted, for example in order to control the flow to or discharge from the container 3 if necessary. However, other information about the general operating state of the fill-level meter 1 can also be communicated.

FIG. 2 shows the circuit layout of the fill-level meter 1: Accordingly, the radar signal S_{HF} to be transmitted is generated as an electrical high-frequency signal S_{HF} in a signal generation unit 11, which is based on a phase locked loop (PLL) in the embodiment shown.

The high-frequency signal SHF is generated according to the FMCW principle with a corresponding ramp-like or sawtooth-like frequency change. The high-frequency signal S_{HF} is then fed via a transmit/receive switch 14 to the antenna 12, from where the high-frequency signal SHE is transmitted as a radar signal S_{HF}. The transmit/receive switch 14 can be designed, for example, as a diplexer or as a duplexer.

The corresponding received signal HF received by the antenna 12 is first fed via the signal switch 14 in an evaluation unit 13 of the fill-level meter to a mixer stage 131. There, the received signal r_{HF} is mixed with the high-frequency signal s_{HF} generated by the signal generation unit 11, whereby a low-frequency intermediate-frequency signal s_{ZF} is generated according to the FMCW principle.

An analog low-pass filter stage 132 may optionally be arranged downstream of the mixer stage 131 in the signal direction in order to avoid the occurrence of mirror frequencies in the digitized signal. However, as can be seen in FIG. 2 from the time curve of the intermediate-frequency signal s_{ZF}, without further measures, the digitized signal does not have an optimally constant frequency or amplitude even after any low-pass filtering. By means of an analog/digital converter stage 133, the intermediate-frequency signal s_{ZF} is time- or value-discretized downstream of the mixer stage 131 in the signal direction so that a transformer stage 135 can create a frequency spectrum s′ₘ therefrom with little computational effort. From the frequency spectrum s′ₘ, the evaluation unit 13 can, in the best case, ascertain the maximum that can be assigned to the reflection on the filling material 2, in order to use this maximum to determine the distance d or the fill level L.

However, the frequency spectrum s′ₘ shown in FIG. 2 shows that, depending on the measuring environment, it can be difficult without further measures to ascertain the maximum that can be assigned to the reflection on the fill level, from the frequency spectrum s′ₘ between the noise- and interference-related maxima. In case of doubt, this results in an incorrect fill-level value L.

As can be seen from FIG. 2 according to the invention, the maximum that can be assigned to the fill level is significantly more pronounced if the corresponding frequency spectrum sₘ or the underlying intermediate-frequency signal s_{ZF} in the signal direction is subjected to averaging over time before the fast Fourier transform. Accordingly, the evaluation unit 13 of the fill-level meter 1 comprises, according to the invention, at a corresponding location, an averaging stage 134, which is based, for example, on arithmetic averaging or summation of the intermediate-frequency signal s_{ZF}. The degree of averaging, i.e., the number of data points to be averaged, does not have to be fixed. The degree of averaging should ideally be adjusted depending on whether or how much the fill level L is currently changing. In principle, various measurement parameters are available for this purpose, including:
the change in distance d ascertained in the current measurement cycle in comparison to the distance d ascertained in a previous measurement cycle,
the (cross-) correlation between the frequency spectrum sₘ or intermediate-frequency signal s_{ZF} ascertained in the current measurement cycle and the frequency spectrum sₘ or intermediate-frequency signal s_{ZF} recorded in a previous measurement cycle, or
an average absolute deviation between the intermediate-frequency signal s_{ZF} recorded in the current measurement cycle and the intermediate-frequency signal s_{ZF} recorded in a previous measurement cycle.

Controlling the degree of averaging is in particular advantageous if it decreases as the change in the fill level increases or if averaging is completely stopped as of a defined limit value of one of the above parameters. In relation to the individual parameters, this means that the degree of averaging decreases as the change in distance increases, as the correlation decreases, and/or as the deviation increases, or vice versa. In order to implement this regulation of the degree of averaging, the evaluation unit 13 must be correspondingly designed to determine one or more of these parameters from the intermediate-frequency signal s_{ZF} or the frequency spectrum sₘ via consecutive measurement cycles and to correspondingly control the averaging stage 134. This type of regulation in particular avoids trailing effects, which in turn makes it easier to find the correct maximum in the frequency spectrum sₘ.

### LIST OF REFERENCE SIGNS

1 Fill-level meter
2 Filling material
3 Container
4 Higher-level unit
11 Signal generation unit
12 Antenna
13 Evaluation unit
14 Transmit/receive switch
131 Mixer stage
132 Low-pass filter stage
133 Analog/digital converter stage
134 Averaging stage
135 Transformer stage
d Distance
h Installation height
L Fill level
R_{HF} Received signal
S_{HF} Radar signal
sₘ, s′ₘ Frequency spectrum
s_{HF} Electrical high-frequency signal
s_{ZF} Intermediate-frequency signal

1-7. (canceled)

8. A frequency modulated continuous wave (FMCW) radar-based distance meter for measuring a distance to an object, comprising:
a signal generation unit designed to generate an electrical high-frequency signal in successive measurement cycles according to the FMCW method;
an antenna by which the high-frequency signal can be transmitted as a radar signal in a direction of the object and can be received as a corresponding received signal after reflection on the object; and
an evaluation unit, including:
a mixer stage designed to generate a low-frequency intermediate-frequency signal per measurement cycle on the basis of the electrical high-frequency signal and the received signal according to the FMCW principle;
an averaging stage designed to average the intermediate-frequency signal in the signal direction over time; and
a transformer stage designed to create a frequency spectrum of the averaged intermediate-frequency signal per measurement cycle,
wherein the evaluation unit is designed to determine the distance on the basis of the frequency spectrum.

9. The distance meter according to claim 8, further comprising:
an analog/digital converter stage designed to digitize the intermediate-frequency signal in the signal direction before the averaging stage.

10. The distance meter according to claim 8, wherein the averaging stage is designed to change or deactivate the averaging over time of the intermediate-frequency signal in the particular measurement cycle depending on:
a change in the distance ascertained in the current measurement cycle in comparison to the distance ascertained in a previous measurement cycle,
a correlation between the frequency spectrum or intermediate-frequency signal ascertained in the current measurement cycle and the frequency spectrum or intermediate-frequency signal recorded in a previous measurement cycle, or
an average absolute deviation between the intermediate-frequency signal recorded in the current measurement cycle and the intermediate-frequency signal recorded in a previous measurement cycle.

11. The distance meter according to claim 10, wherein the averaging stage is designed to change a degree of averaging of the averaging over time of the intermediate-frequency signal depending on the change in distance, the correlation or the deviation in the current or subsequent measurement cycle such that:
the degree of averaging decreases as the change in distance increases, the correlation decreases, and/or the deviation increases; or
the degree of averaging increases as the correlation increases, the change in distance decreases, and/or the deviation decreases.

12. The distance meter according to claim 8, wherein the averaging stage is designed to average the intermediate-frequency signal over time by:
arithmetic averaging,
summation,
median formation,
a finite impulse response (FIR) filter, or
an infinite impulse response (IIR) filter.

13. A method for measuring a distance to an object using the frequency modulated continuous wave (FMCW) principle, comprising the following method steps, which are repeated in successive measurement cycles:
generating the electrical high-frequency signal according to the FMCW method;
transmitting the high-frequency signal as a radar signal in a direction of the object;
receiving a corresponding received signal after reflection of the radar signal on the object;
mixing the electrical high-frequency signal and the received signal to form a low-frequency intermediate-frequency signal;
averaging the intermediate-frequency signal over time;
creating a frequency spectrum of the evaluation signal averaged over time; and
determining the distance based on the frequency spectrum.
